(19) United States
(12) Patent Application Publication
(10) Pub. No.: US 2025/0234092 A1
(43) Pub. Date: Jul. 17, 2025

(54) FLEXIBLE ROOM ENVIRONMENT CONFIGURATION SYSTEMS AND METHODS

(71) Applicant: Shure Acquisition Holdings, Inc., Niles, IL (US)

(72) Inventor: Bijal Joshi, Elk Grove Village, IL (US)

(21) Appl. No.: 19/016,560

(22) Filed: Jan. 10, 2025

Related U.S. Application Data
(60) Provisional application No. 63/620,583, filed on Jan. 12, 2024.

(51) Int. Cl. H04N 23/69; H04L 12/18; H04N 23/61; H04N 23/90

(52) U.S. Cl. CPC H04N 23/69; H04L 12/1831; H04N 23/61; H04N 23/90

(57) ABSTRACT

Systems and methods for determining the physical configurations of flexibly configurable environments and optimizing the configuration of cameras and/or microphones towards talkers and objects are disclosed. The automatic setup of the optimal camera and/or microphone configurations for the various physical configurations of an environment can improve the experience for participants in a conferencing session.

### CROSS-REFERENCE

This application claims priority to U.S. Provisional Patent Application No. 63/620,583, filed on Jan. 12, 2024, the contents of which are incorporated herein by reference in their entirety.

### TECHNICAL FIELD

This application generally relates to the configuration of cameras and/or microphones in environments that have flexible physical configurations, and more specifically, to systems and methods for determining the physical configurations of environments based on the locations of talkers and/or objects, and optimizing the configuration of the cameras and/or microphones towards the talkers and/or objects.

### BACKGROUND

Conferencing environments, such as conference rooms, boardrooms, video conferencing settings, and the like, can involve the use of microphones (including microphone arrays) for capturing sound from audio sources in the environment (also known as a near end) and loudspeakers for presenting audio from a remote location (also known as a far end). For example, persons in a conference room may be conducting a conference call with persons at a remote location. Typically, speech and sound from the conference room may be captured by microphones and transmitted to the remote location, while speech and sound from the remote location may be received and played on loudspeakers in the conference room. Multiple microphones may be used in order to optimally capture the speech and sound in the conference room.

Such conferencing environments may also include one or more image capture devices, such as cameras, which can be used to capture and provide images and/or video of persons and objects in the environment to be transmitted for viewing at the remote location and/or for other purposes, such as recording an event for future playback. However, it may be difficult for viewers to see particular talkers in the environment if, in one example, a camera is configured to capture the entire room or if, in another example, a camera is fixed to capture only a specific pre-configured portion of the room and the talkers move in and out of that portion of the room during the event. Talkers may include, for example, humans in the environment that are speaking or making other sounds. In addition, in environments where multiple cameras and/or multiple microphones are desirable for adequate video and audio coverage, it may be difficult to accurately determine the location of a talker in the environment and/or to identify which of the cameras should be directed towards the talker.

Furthermore, environments are often physically configurable in various ways to accommodate different types of events and meetings and/or numbers of people. As examples, a typical environment could be set up as a conference room with seating around a central conference table, as a classroom with desks or tables for students and a podium for a teacher at a front of the room, and/or as a collaboration space with multiple tables throughout the room having seating around each table. Using different camera configurations, e.g., camera presets and camera selections, may be preferred to optimally capture images and video of event participants due to the numerous potential physical configurations of an environment. For example, a camera configuration that may be appropriate to capture participants in a conference room configuration of the environment may not be optimal to capture students and a teacher in a classroom configuration of the environment since talkers would likely be in different locations and orientations in the two different physical configurations. Similarly, a microphone coverage area configuration that may be appropriate to capture sound from talkers in a collaboration space configuration of the environment may not be optimal to capture sound from talkers in a classroom configuration of the environment.

Using a non-optimal camera and/or microphone configuration for a particular physical configuration of an environment can therefore cause a talker to not be suitably captured by a camera and/or a microphone, or possibly not be captured by a camera and/or a microphone at all, which can result in a poor conferencing experience. In addition, it may be difficult, time consuming, and/or require specialized personnel to manually change a configuration of cameras and/or microphones to a suitable configuration when the physical configuration of an environment changes. For example, it may be complicated to properly set up the cameras and/or microphones in accordance with how the environment is being utilized in order to ensure a consistent user experience.

Accordingly, there is a need for systems and methods that can automatically configure an optimal camera configuration and/or optimal talker coverage for microphones for various physical configurations of an environment in order to improve the experience for participants in a conferencing session.

### SUMMARY

The techniques of this disclosure are directed to solving the above-noted problems by providing systems and methods that are designed to, among other things: (1) compare sensor data associated with talkers in an environment to environment configuration templates that are each associated with a particular configuration of the environment; (2) configure microphones and cameras in the environment based on a matching environment configuration template; (3) determine a physical configuration of a room based on the locations of talkers in an environment; and (4) configure microphones and cameras in the room to capture images of the talkers based on the determined physical configuration.

In an embodiment, a method includes receiving sensor data associated with one or more talkers located in an environment; comparing the sensor data to a plurality of environment configuration templates, where each of the plurality of environment configuration templates is associated with a particular physical configuration of the environment; and when the sensor data matches one of the plurality of environment configuration templates: selecting a matching environment configuration template, and configuring one or more cameras located in the environment, based on the matching environment configuration template.

In another embodiment, a system includes a microphone configured to determine locations of one or more talkers in an environment, based on audio sensed by the microphone and associated with the one or more talkers, and an aggregator unit in communication with the microphone and one or more cameras. The aggregator unit is configured to determine a physical configuration of the room, based on the locations of the one or more talkers, and configure one or more cameras in the room to capture images of the one or more talkers, based on the determined physical configuration.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a block diagram of an exemplary conferencing system with multiple microphone arrays, multiple cameras, and an environment configuration database, in accordance with some embodiments.

FIG. 2 is a block diagram of a microphone array configured for automated detection of audio activity that is usable in the system of FIG. 1, in accordance with some embodiments.

FIG. 3 is a flowchart illustrating operations for the automated configuration of cameras and/or microphones in a conferencing environment based on sensor data associated with talkers and a matching environment configuration template, in accordance with some embodiments.

FIG. 4 is a flowchart illustrating operations for comparing sensor data to environment configuration templates, in accordance with some embodiments.

FIG. 5 is an exemplary top-down depiction of a conferencing environment in a meeting room configuration and with a microphone, camera, and camera presets, in accordance with some embodiments.

FIG. 6 is an exemplary top-down depiction of a conferencing environment in a classroom configuration and with a microphone, cameras, and camera presets, in accordance with some embodiments.

FIG. 7 is an exemplary top-down depiction of a conferencing environment in a collaboration space configuration and with a microphone, cameras, and camera presets, in accordance with some embodiments.

FIG. 8 is an exemplary top-down depiction of a conferencing environment in a boardroom configuration and with microphones, cameras, and camera presets, in accordance with some embodiments.

### DETAILED DESCRIPTION

The systems and methods described herein can optimize the configuration of cameras and/or microphones in an environment by automatically determining the particular physical configuration of the environment, based on sensor data associated with talkers and/or objects. The environment may include a flexibly configurable room, for example, that can be set up in different ways to accommodate various types of events and meetings and/or numbers of people. Such an environment could be set up, for example, as a conference room, classroom, collaboration space, or boardroom having different seating arrangements, table and desk placements, etc. that typically results in differing locations and/or orientations of talkers. The talkers may be participating in, for example, a conference call, telecast, webcast, class, seminar, performance, sporting event, etc.

In this way, the sensor data can be used to more appropriately configure the microphone coverage, the selection of cameras, and/or the setting of camera presets in order to optimally capture audio, images, and/or video of talkers in the environment that can be transmitted to remote far end participants of a conferencing session and/or for other purposes. For example, the sensor data may include audio localization information determined by the microphone array (or microphone) such as locations of talkers in the environment, LiDAR or infrared sensor data to detect talker presence, and/or optical sensors to analyze room furnishings and talker presence. This collective information may be used to determine a physical configuration of the environment. Determining the physical configuration of the environment can include comparing the talker locations to potential environment configuration templates to determine a matching environment configuration template corresponding to the physical configuration. As another example, the sensor data may include the locations of objects in the environment that are sensed by the microphone array and/or cameras, and the detected object locations may be used to determine a physical configuration of the environment. A further example includes that the sensor data is provided by a room partition sensor (e.g., infrared sensor, contact sensor, etc.) to indicate the state of a physically divisible environment, such as whether movable partitions or walls are open, closed, attached, detached, etc., and the detected state of the divisible environment may be used to determine a physical configuration of the environment.

The matching environment configuration template may be utilized to configure and allocate the microphone coverage and/or the cameras in the environment for the corresponding physical configuration, such as how a coverage area of a microphone is configured, which cameras may be selected for use, and/or the camera presets that may be utilized. A camera preset may include a particular location in the environment, for example. The camera preset may correspond to specific views of the camera, such as a view of a particular location and/or a zoom setting that would capture a particular portion of the environment. The camera presets may include particular settings for angle, tilt, zoom, and/or framing of images and/or video captured by the camera. After the cameras have been configured based on the matching environment configuration template, a camera controller and/or an aggregator can select which of the allotted cameras and/or which allotted camera preset to utilize to capture images and/or video of an active talker during a conferencing session.

The systems and methods described herein can automatically configure an optimal microphone and/or camera configuration for the particular physical configuration of an environment, resulting in an improved experience for conferencing session participants. Remote far end participants of a conferencing session may particularly benefit from the systems and methods described herein due to the more accurate and optimal audio, image, and/or video capture of talkers in the local environment.

As used herein, the terms “lobe” and “microphone lobe” refer to an audio beam generated by a given microphone array (or array microphone) to pick up audio signals at a select location, such as the location towards which the lobe is directed. While the techniques disclosed herein are described with reference to microphone lobes generated by array microphones, the same or similar techniques may be utilized with other forms or types of microphone coverage (e.g., a cardioid pattern, etc.) and/or with microphones that are not array microphones (e.g., a handheld microphone, boundary microphone, lavalier microphones, etc.). Thus, the term “lobe” is intended to cover any type of audio beam or coverage.

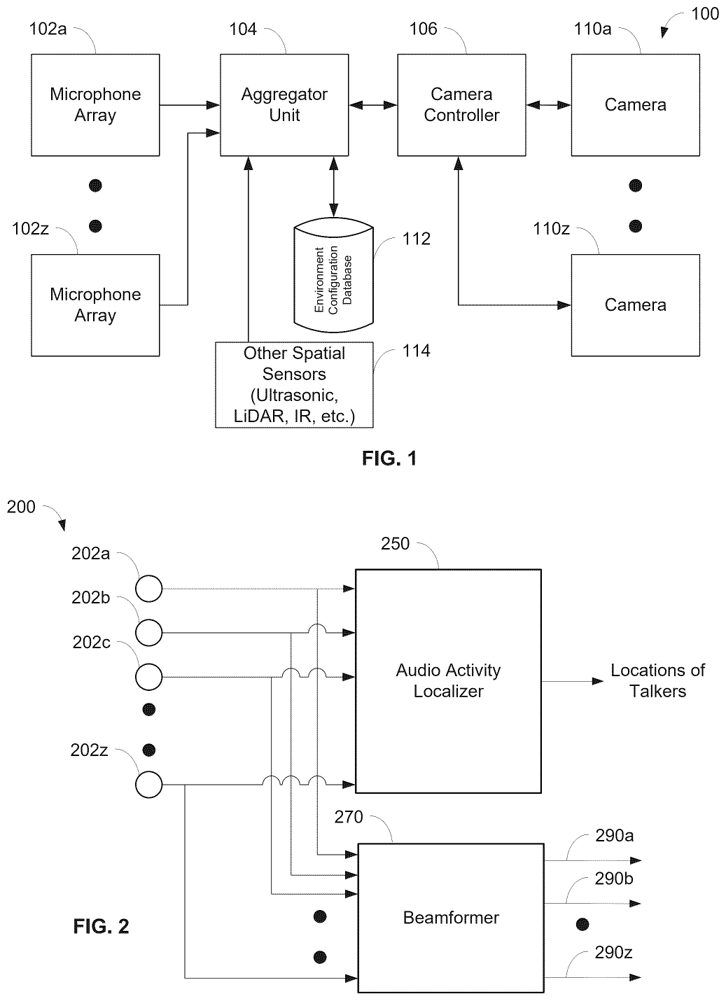

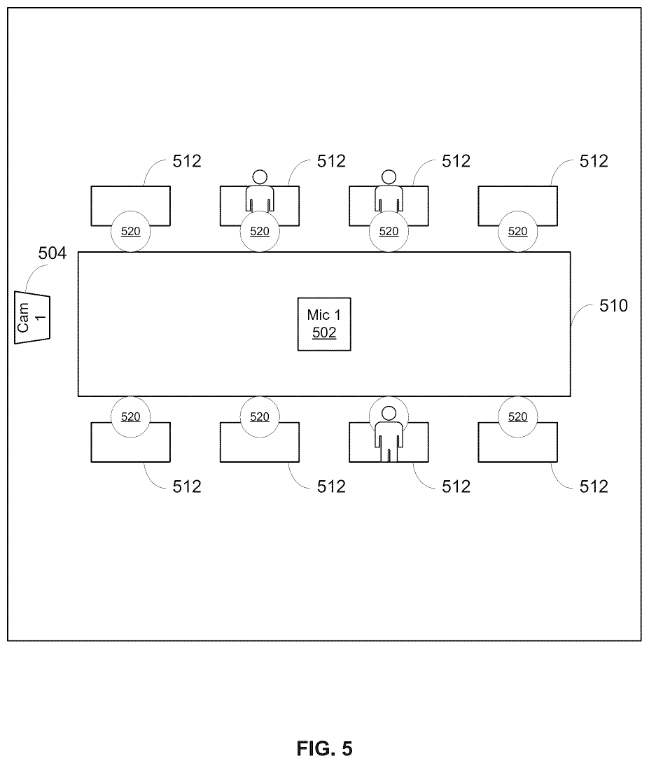

FIG. 1 shows a block diagram of a conferencing system 100 that includes one or more microphone arrays 102a, . . . , z that can detect the locations of objects and talkers in an environment, as well as an aggregator unit 104 that can receive sensor data, e.g., the locations of talkers and/or objects from the microphone arrays 102a, . . . , z, and provide the locations to a camera controller 106 for positioning one or more cameras 110a, . . . , z. The aggregator unit 104 may be in communication with an environment configuration database 112 that may store environment configuration templates that each correspond to a particular physical configuration of the environment. The environment configuration templates may include, for example, the potential locations of talkers and/or objects, potential states of sensor data (e.g., whether a partition sensor is open or closed, etc.), and/or potential user inputs (e.g., user interface settings, etc.) for particular physical configurations of the environment. For example, the environment configuration template for a conference room configuration (e.g., as shown in FIG. 5) may include the potential locations 512 of talkers at various seating areas, and/or the potential location of the table 510 in the environment.

The camera controller 106 may select which of the cameras 110a, . . . , z to utilize for capturing images and/or video of a particular location, e.g., where an active talker is located. The selection by the camera controller 106 of the camera 110a, . . . , z to utilize may be based on one or more received locations of a talker, for example. The camera controller 106 may provide appropriate signals to the cameras 110a, . . . , z to cause the cameras 110a, . . . , z to move and/or zoom, for example. In some embodiments, the camera controller 106 and one or more of the cameras 110a, . . . , z may be integrated together. In other embodiments, the camera controller 106 can be part of one or more microphone arrays 102a, . . . , z and/or the aggregator unit 104. The components of the system 100 may be in wired and/or wireless communication with the other components of the system 100. The environment where the conferencing system 100 is located may include a flexibly configurable space such as, for example, a conference room, boardroom, classroom, meeting room, huddle room, office, theatre, arena, auditorium, music venue, etc.

The microphone arrays 102a, . . . , z may detect and capture sounds from audio sources within an environment. Such sounds may include desired sounds (e.g., human talkers or speakers) and/or undesired sounds (e.g., background noise, spurious noise, non-human noise, non-voice human noise, and/or unwanted human voice). The microphone arrays 102a, . . . , z may be capable of forming one or more pickup patterns with lobes that can be steered to sense audio in particular locations within the environment. The microphone arrays 102a, . . . , z may communicate with the camera controller 106 and/or the cameras 110a, . . . , z via a suitable application programming interface (API).

The cameras 110a, . . . , z may capture still images and/or video of the environment where the conferencing system 100 is located. In some embodiments, any of the cameras 110a, . . . , z may be a standalone camera, and in other embodiments, any of the cameras 110a, . . . , z may be a component of an electronic device, e.g., smartphone, tablet, etc. Any of the cameras 110a, . . . , z may be a pan-tilt-zoom (PTZ) camera that can physically move and zoom to capture desired images and video, or may be a virtual PTZ camera that can digitally crop and zoom images and videos into one or more desired portions.

In addition to the cameras 110a, . . . , z capturing and transmitting images and/or video for transmission to the far end of a conferencing session, the captured images and/or videos from the cameras 110a, . . . , z. may be transmitted to the aggregator unit 104. The captured images and/or videos from the cameras 110a, . . . , z may be utilized by the aggregator unit 104 to determine the locations of talkers and/or objects in the environment, such as by using image recognition, facial recognition, presence detection, and/or other suitable techniques.

In embodiments, other types of spatial sensors 114 may be included in the conferencing system 100 to detect the locations of objects and talkers in an environment, such as ultrasonic sensors, LiDAR (light detection and ranging) sensors, infrared (IR) sensors, acoustic sensors, optical sensors, and/or other types of spatial sensors. The spatial sensors 114 may be in communication with the aggregator unit 104 to communicate sensor data that can indicate the locations of objects and talkers in an environment and/or be used to determine the locations of objects and talkers in an environment.

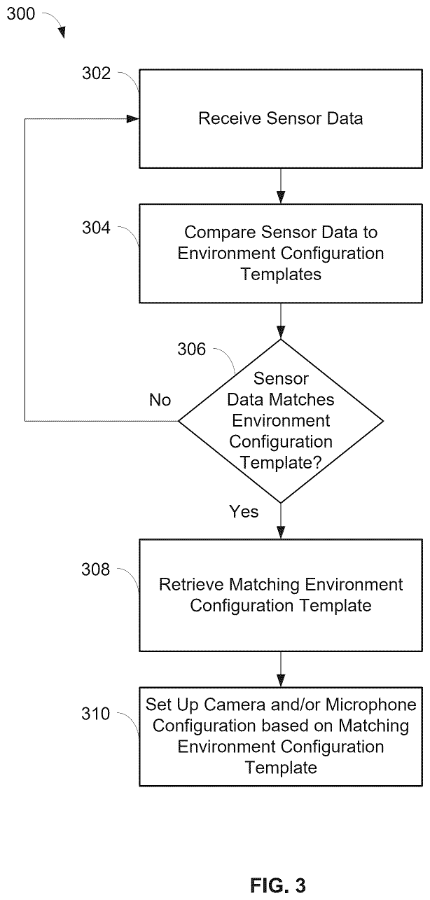

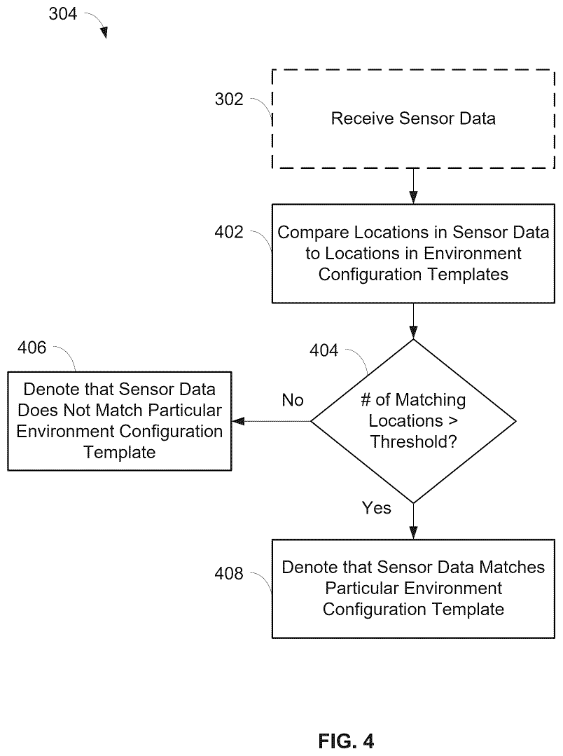

Some or all of the components of the conferencing system 100 may be implemented using software executable by one or more computers, such as a computing device having a processor and memory (e.g., a personal computer (PC), a laptop, a tablet, a mobile device, a smart device, thin client, etc.), and/or by hardware (e.g., discrete logic circuits, application specific integrated circuits (ASIC), programmable gate arrays (PGA), field programmable gate arrays (FPGA), digital signal processors (DSP), microprocessor, etc.). For example, some or all components of the conferencing system 100 may be implemented using discrete circuitry devices and/or using one or more processors (e.g., audio processor and/or digital signal processor) executing program code stored in a memory (not shown), the program code being configured to carry out one or more processes or operations described herein, such as, for example, the methods shown in FIGS. 3 and 4. Thus, in embodiments, the conferencing system 100 may include one or more processors, memory devices, computing devices, and/or other hardware components not shown in FIG. 1. It should be understood that the components shown in FIG. 1 are merely exemplary, and that any number, type, and placement of the various components of the conferencing system 100 are contemplated and possible. In some embodiments, the components of the conferencing system 100 may be physically located in and/or dedicated to a particular environment. In other embodiments, the components of the conferencing system 100 may be part of a network and/or distributed in a cloud-based environment.

FIG. 2 shows a block diagram of a microphone array 200, such as any of the microphone arrays 102a, . . . , z of FIG. 1, that is usable in the conferencing system 100 of FIG. 1 for detecting sounds from audio sources in an environment. The microphone array 200 may include any number of microphone elements 202a,b,c, . . . , z, for example, and be able to form one or more pickup patterns with lobes so that the sound from the audio sources can be detected and captured. Each of the microphone elements 202a,b,c, . . . , z in the microphone array 200 may detect sound and convert the sound to an analog audio signal. The microphone array 200 may also include an audio activity localizer 250 in wired or wireless communication with the microphone elements 202a,b,c, . . . , z, and a beamformer 270 in wired or wireless communication with the microphone elements 202a,b,c, . . . , z.

The microphone elements 202a,b,c, . . . , z may each be a MEMS (micro-electrical mechanical system) microphone with an omnidirectional pickup pattern, in some embodiments. In other embodiments, the microphone elements 202a,b,c, . . . , z may have other pickup patterns and/or may be electret condenser microphones, dynamic microphones, ribbon microphones, piezoelectric microphones, and/or other types of microphones. In embodiments, the microphone elements 202a,b,c, . . . , z may be arrayed in one dimension or multiple dimensions.

Other components in the microphone array 200, such as analog to digital converters, processors, and/or other components (not shown), may process the analog audio signals and ultimately generate one or more digital audio output signals. The digital audio output signals may conform to suitable standards and/or transmission protocols for transmitting audio. In embodiments, each of the microphone elements in the microphone array 200 may detect sound and convert the sound to a digital audio signal.

One or more digital audio output signals 290a,b, . . . , z may be generated corresponding to each of the pickup patterns. The pickup patterns may be composed of one or more lobes, e.g., main, side, and back lobes, and/or one or more nulls. The pickup patterns that can be formed by the microphone array 200 may be dependent on the type of beamformer used with the microphone elements, such as beamformer 270. For example, a delay and sum beamformer may form a frequency-dependent pickup pattern based on its filter structure and the layout geometry of the microphone elements. As another example, a differential beamformer may form a cardioid, subcardioid, supercardioid, hypercardioid, or bidirectional pickup pattern.

The audio activity localizer 250 may determine the location of audio activity in an environment based on the audio signals from the microphone elements 202a,b,c, . . . , z. In embodiments, the audio activity localizer 250 may utilize a Steered-Response Power Phase Transform (SRP-PHAT) algorithm, a Generalized Cross Correlation Phase Transform (GCC-PHAT) algorithm, a time of arrival (TOA)-based algorithm, a time difference of arrival (TDOA)-based algorithm, or another suitable sound source localization algorithm. The audio activity that is detected may include desired audio sources, such as human talkers, and/or undesired audio sources, such as noise from computer equipment, etc. The location of the audio activity may be indicated by a set of three-dimensional coordinates relative to the location of the microphone array 200, such as in Cartesian coordinates (i.e., x, y, z), or in spherical coordinates (i.e., radial distance/magnitude r, elevation angle θ (theta), azimuthal angle φ (phi)). It should be noted that Cartesian coordinates may be readily converted to spherical coordinates, and vice versa, as needed. In embodiments, the audio activity localizer 250 may be included in the microphone array 200, may be included in another component, or may be a standalone component.

FIGS. 5-8 are exemplary top-down depictions of environments in which the systems and methods disclosed herein may be used. In particular, each of FIGS. 5-8 show an environment having a particular physical configuration with objects (e.g., tables, chairs, podium, etc.), and including one or more microphone arrays and one or more cameras. Each of FIGS. 5-8 also show exemplary locations of camera presets and persons for the associated physical configurations of the environments. It should be appreciated that while the objects, microphone arrays, cameras, camera presets, and persons are shown in particular quantities and locations in the environments of FIGS. 5-8, other quantities and locations are possible and contemplated for any of the depicted physical configurations. It should further be appreciated that the systems and methods described herein can be utilized for physical configurations of an environment other than those depicted in FIGS. 5-8, which may have any quantities and locations of objects, microphone arrays, cameras, camera presets, and/or persons.

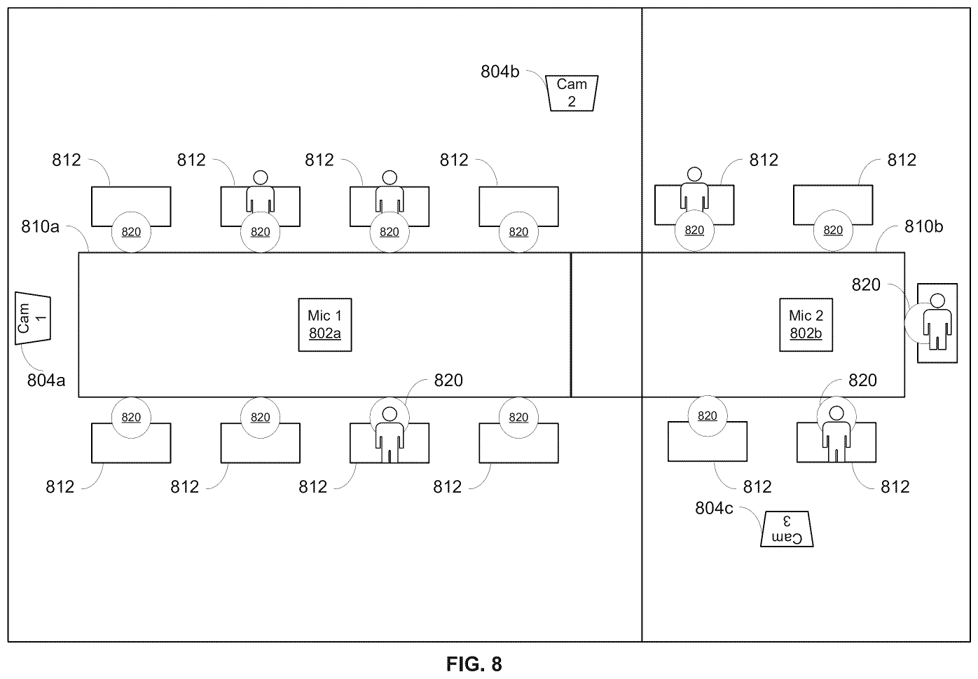

As non-limiting examples, in the environments of FIGS. 5-8, the microphone arrays may be located on the ceiling of the room, and the cameras may be located on the walls of the room. The walls of each room in FIGS. 5-7 and of the multiple rooms in FIG. 8 are denoted by the solid lines around the perimeters in each figure. The use of multiple microphone arrays may improve the sensing and capture of sounds from audio sources in the environment, while the use of multiple cameras may enable the capture of more and varied types of images and/or video of the environment. For example, certain microphone arrays may be utilized to sense particular talkers, and/or certain cameras may be utilized to capture wider views of the environment, close-ups of talkers, etc.

FIG. 5 depicts an exemplary environment that has a physical configuration corresponding to a conference room that includes one microphone array 502 (e.g., microphone array 200) and one camera 504. The physical configuration of the environment shown in FIG. 5 also includes a table 510 around which are locations 512 of seating that is arranged where persons can sit. The camera presets 520 of FIG. 5 may accordingly be located at or around the locations 512 such that the camera 504 may be controlled to point at a particular camera preset 520 during a conferencing session, e.g., to capture an image and/or video of a person talking at a particular location 512.

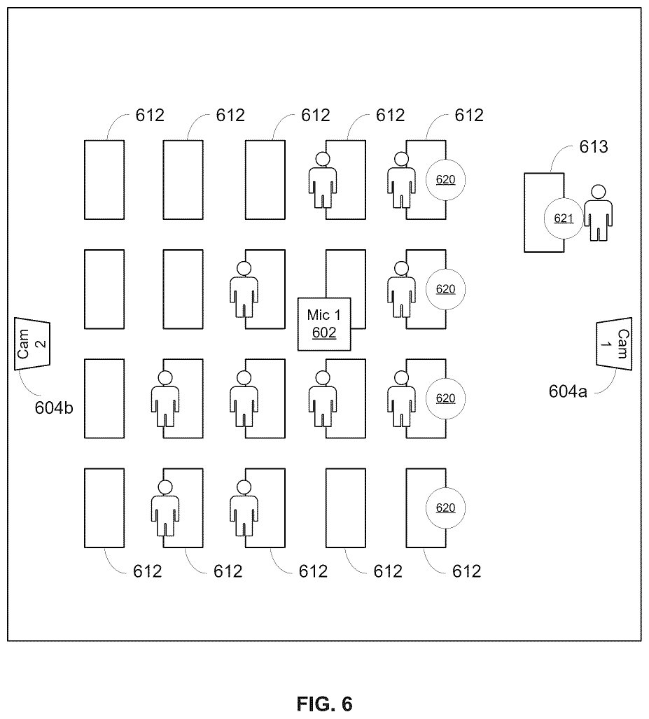

FIG. 6 depicts an exemplary environment that has a physical configuration corresponding to a classroom that includes one microphone array 602 (e.g., microphone array 200) and two cameras 604a, 604b. The physical configuration of the environment shown in FIG. 6 also includes locations 612 of tables, desks, chairs, etc., and a location 613 of a podium or presentation space. In this physical configuration, the persons (e.g., students) at the locations 612 may be facing the person (e.g., a teacher or professor) at location 613. Accordingly, there may be camera presets 620 associated with camera 604a that are located at or around some or all of the locations 612. For example, in FIG. 6, camera presets 620 are shown located at the head of each row of locations 612 so that a talker in a particular row may be captured by the camera 604a. The camera 604a may be used to capture talkers at locations 612 since the camera 604a is oriented to point towards these talkers. There may also be a camera preset 621 associated with camera 604b that is located at or around the location 613, so that camera 604b can capture the talker at location 613. The camera 604b may be used to capture the talker at location 613 since the camera 604b is oriented to point towards this talker.

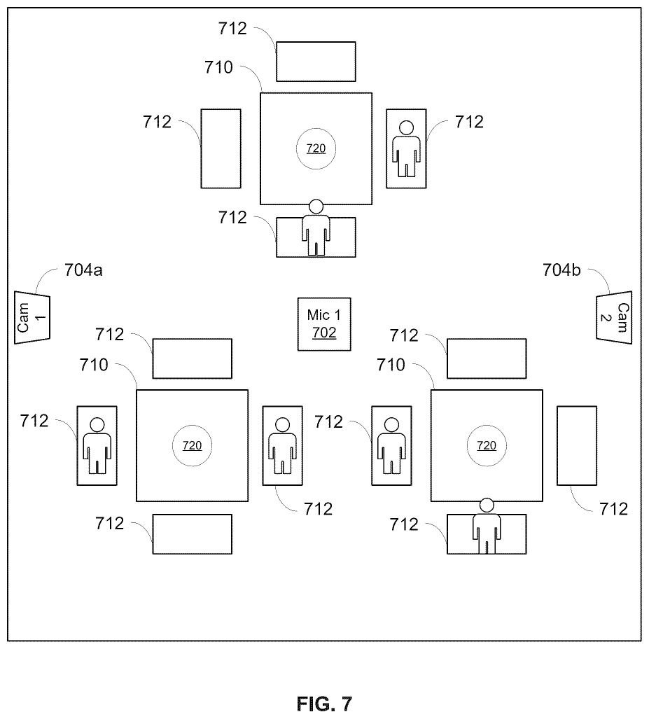

FIG. 7 depicts an exemplary environment that has a physical configuration corresponding to a collaboration space that includes one microphone array 702 (e.g., microphone array 200) and two cameras 704a, 704b. The physical configuration of the environment shown in FIG. 7 also includes a number of tables 710 around each of which are locations 712 of seating that is arranged where persons can sit. The camera presets 720 of FIG. 7 may accordingly be located at or around the tables 710 and/or the locations 712 such that the cameras 704a, 704b may be controlled to point at a particular camera preset 720 during a conferencing session, e.g., such as when a person at a particular table 710 is talking.

In one embodiment, a particular camera preset 720 may be associated with one of the cameras 704a, 704b so that a particular camera may capture images and/or video at the camera preset 720. In another embodiment, the camera presets 720 may be associated with both cameras 704a, 704b so that either camera may capture images and/or video at the camera preset 720. The camera 704a, 704b that may be used to capture a particular talker may depend on the position and orientation of the talker with respect to the camera 704a, 704b. For example, a talker on the right side of one of the tables 710 may best be captured by camera 704a, while a talker on the left side of one of the tables 710 may best be captured by camera 704b.

FIG. 8 depicts an exemplary environment that has a physical configuration corresponding to a boardroom that includes two microphone arrays 802a, 802b (e.g., microphone array 200) and three cameras 804a, 804b, 804c. The physical configuration of the environment shown in FIG. 8 also includes tables 810a, 810b around which are locations 812 of seating that is arranged where persons can sit. The environment of FIG. 8 may include two rooms, as denoted by the two solid-lined boxes, such that persons (e.g., at locations 812) and objects in the environment may be located in either room. The two rooms may be usable as a single space or divisible into two spaces, such as through using a moveable partition or wall. The state of the environment may be detected using a room partition sensor or other suitable sensor to determine, for example, whether the environment is physically configured as a single space (e.g., when the moveable partition is open) or as two spaces (e.g., when the movable partition is closed). While two rooms are depicted in FIG. 8 for the environment, any number of divisible spaces for a physically divisible environment are contemplated and possible.

As shown in FIG. 8, cameras 804a and 804b may be located in the larger room, and camera 804c may be located in the smaller room. The camera presets 820 of FIG. 8 may be located at or around the locations 812 such that cameras 804a, 804b, 804c may be controlled to point at a particular camera preset 820 during a conferencing session, e.g., to capture an image and/or video of a person talking at a particular location 812.

In one embodiment, a particular camera preset 820 may be associated with one of the cameras 804a, 804b, 804c so that a particular camera may capture images and/or video at the camera preset 820. In another embodiment, the camera presets 820 may be associated with two or more of the cameras 804a, 804b, 804c so that one of the cameras may capture images and/or video at the camera preset 820. The camera 804a, 804b, 804c that may be used to capture a particular talker may depend on the position and orientation of the talker with respect to the camera 804a, 804b, 804c. For example, a talker on the upper side of the tables 810a, 810b may best be captured by camera 804a or 804c, while a talker on the bottom side of the tables 810a, 810b may best be captured by camera 804a or 804b. As another example, a talker at the right end of the table 810b may best be captured by any of camera 804a, 804b, or 804c

As described in the process 300 shown in FIG. 3, the microphone and/or camera configuration for a flexibly configurable environment may be automatically determined and set up, based on sensor data associated with talkers and/or objects in the environment. In particular, the sensor data may be utilized to determine a environment configuration template that is associated with a particular physical configuration of the environment, and the process 300 may result in the matching environment configuration template being used to set up the microphone and/or camera configuration for that particular physical configuration.

At step 302 of the process 400, sensor data associated with talkers and/or objects located in the environment may be received at the aggregator unit 104. The sensor data may be obtained from, for example, acoustic sensors (e.g., microphone arrays 102, etc.), optical sensors (e.g., cameras 110), and/or other types of spatial sensors 114 (e.g., ultrasonic sensors, LiDAR sensors, IR sensors, etc.). In an embodiment, the sensor data may include the locations of one or more talkers and/or objects in the environment that has been determined by a microphone array 102. An audio activity localizer 250 in the microphone array 102 may execute an audio localization algorithm to determine the location of a talker by sensing audio activity, e.g., speech, from the talker. Audio localization information typically contains azimuth, elevation, and radius coordinates representing an estimated location of the talker or other audio source relative to the microphone array 102.

In another embodiment, the sensor data may include the locations of one or more talkers and/or objects in the environment that have been determined by one or more of the cameras 110. A camera 110, the camera controller 106, and/or the aggregator unit 104 may process captured images and/or video and utilize image recognition, facial recognition, presence detection, and/or other suitable techniques to determine the locations of talkers and/or objects in the environment. In a further embodiment, the sensor data may include a signal from a room partition sensor that indicates whether a movable partition or wall is open, closed, attached, detached, etc., which can be used to determine how a divisible environment is currently configured (e.g., as a single space or multiple spaces).

For example, in the conference room of FIG. 5, the locations of talkers can be sensed at various locations 512 in the environment, and their locations may be transmitted to the aggregator unit 104 at step 302. As another example, in the classroom of FIG. 6, the location of computing or presentation equipment near location 613 (e.g., where the teacher may be located) may be sensed and transmitted to the aggregator unit 104 at step 302. As a further example, in the collaboration space of FIG. 7, the locations of the multiple tables 710 and/or the locations 712 of talkers around the tables 710 can be sensed and transmitted to the aggregator unit 104 at step 302. The locations of the talkers and/or objects in an environment may be sensed by one or more of the microphone arrays 102, one or more of the cameras 110, and/or one or more of the other spatial sensors 114.

At step 304, the sensor data received at step 302 may be compared by the aggregator unit 104 to predetermined environment configuration templates. The environment configuration templates may be stored in an environment configuration database 112 that is accessible by the aggregator unit 104. Each of the environment configuration templates may be associated with a particular physical configuration of the environment, and may include the potential locations of talkers and/or objects for that particular physical configuration, in some embodiments.

For example, in each of the exemplary environments of FIGS. 5-8, the locations 512, 612, 613, 712, 812 where talkers may potentially be located may be stored in respective environment configuration templates for the particular corresponding physical configurations of the environment. The potential locations of furniture, e.g., tables 510, 710, 810a, 810b, may also be stored in the respective environment configuration templates. The environment configuration templates for the conference room, classroom, collaboration space, and boardroom physical configurations shown in FIGS. 5-8, respectively, may therefore include different potential locations of talkers and/or objects that can sufficiently and uniquely identify how an environment has been physically set up for a particular meeting or event. For example, the conference room physical configuration of FIG. 5 may be differentiated from the boardroom physical configuration of FIG. 8 due to the additional table 810b and additional locations 812 for seating. As another example, the classroom physical configuration of FIG. 6 may be differentiated from the collaboration space configuration of FIG. 7 due to the greater number of desks and a podium in the classroom, as compared to the fewer number of tables in the collaboration space.

In embodiments, the potential states of a divisible environment (e.g., as one large space or multiple spaces) may be stored in environment configuration templates. The state of a divisible environment may be detected, for example, based on: a signal from a room partition sensor, images and/or video captured by a camera, whether single or multiple audio and video channels are being transmitted during a conferencing session, and/or on user input related to the state of the divisible environment. As an example, the boardroom environment of FIG. 8 with two rooms configured as a single large space (e.g., when a movable partition is open) can therefore be differentiated from when each room is being used individually (e.g., when the movable partition is closed).

An embodiment of step 304 of the process 400 is shown in FIG. 4 as a process 304. As shown in FIG. 4, the process 304 may begin at step 402 after receiving sensor data at step 302, described previously. At step 402, the locations of talkers and/or objects in the received sensor data may be compared to the potential locations of talkers and/or objects in the environment configuration templates. The aggregator unit 104 may retrieve each of the environment configuration templates and compare the potential locations of talkers and/or objects to the locations of talkers and/or objects in the sensor data.

In embodiments, the locations of talkers and/or objects in the sensor data may not have to exactly match the potential locations of talkers and/or objects in an environment configuration template in order to be deemed a matching location. For example, the location of a talker and/or object in the sensor data may be deemed a match if it is within a certain threshold of a potential location of a talker and/or an object in an environment configuration template. It may be beneficial at step 402 to deem such “close” locations as matches since talkers and/or objects may not be exactly located in particular locations in an environment. As examples, talkers may move their chairs away from a table, or furniture may have been slightly moved from a particular location.

When a number of matching locations of talkers and/or objects in the sensor data exceeds a threshold of potential locations of talkers and/or objects in a particular environment configuration template at step 404 (“YES” branch), then the process 400 may proceed to step 406 to denote that the sensor data matches that particular environment configuration template. However, when a number of matching locations of talkers and/or objects in the sensor data does not exceed a threshold of potential locations of talkers and/or objects in a particular environment configuration template, e.g., at step 404 (“NO” branch), then the process 400 may proceed to step 408 to denote that the sensor data matches that particular environment configuration template. In one embodiment, the process 304 may be repeated for each of the potential environment configuration templates before determining a matching environment configuration template. In another embodiment, the process 304 may be performed until a matching environment configuration template is found.

In embodiments, the threshold of matching locations of talkers and/or objects may be a certain numerical threshold or percentage threshold in order to deem that a particular environment configuration template matches the physical configuration of the environment. For example, in FIG. 7, the six talkers present in the environment may meet a threshold of matching potential locations of talkers (e.g., out of a possible twelve potential locations of talkers), such that the environment configuration template for a collaboration space may be deemed a match. As another example, in FIG. 6, the presence of furniture at locations 612 and location 613 may meet a threshold of matching potential locations of objects so that the environment configuration template for a classroom may be deemed a match.

Returning to FIG. 3, at step 306, it can be determined whether the sensor data matches a particular environment configuration template, e.g., based on the process 304 depicted in FIG. 4 that denotes whether there is a matching environment configuration template. If there is not a matching environment configuration template at step 306 (“NO” branch), then the process 300 may return to step 302 to receive further sensor data. However, if there is a matching environment configuration template at step 306 (“YES” branch), then the process 300 may proceed to step 308. At step 308, the matching environment configuration template may be retrieved by the aggregator unit 104 from the environment configuration database 112.

In embodiments, a user may utilize a user interface of the system 100 to select a particular

environment configuration template from predefined environment configuration templates so that the selected environment configuration template is retrieved by the aggregator unit 104 at step 308 from the environment configuration database 112. Such predefined environment configuration templates may have been provided by an installer, for example, to correspond to potential physical configurations of the environment. The system 100 may provide the sensor data received at step 302 and/or a recommended matching environment configuration template, e.g., on the user interface, to assist the user in selecting an environment configuration template, in some embodiments.

The aggregator unit 104 may use the retrieved matching environment configuration template at step 310 to set up the microphone and/or camera configuration for the corresponding physical configuration of the environment. Configuring the cameras in an environment may include, for example, setting one or more presets for the cameras 110, selecting particular cameras 110 to be able to capture images and/or video of talkers, and/or transmitting locations of talkers to the camera controller 106 and/or to the cameras 110 to cause the cameras 110 to point towards the locations of the talkers and/or towards the camera presets. In embodiments, the locations of talkers may be periodically or continuously transmitted to the camera controller 106 and/or to the cameras 110 to cause the cameras 110 to freely follow the talkers as they move about the environment.

The setting of camera presets for a particular matching environment configuration template may include transmitting the camera presets to the camera controller 106 and/or the cameras 110. In this way, when talkers in the environment are subsequently detected at or near the location of a camera preset, one of the cameras 110 may be controlled to point towards the camera preset and the talker. Exemplary camera presets 520, 620, 720, 820 are shown in FIGS. 5-8, respectively. The camera presets may include preconfigured pan, tilt, and/or zoom settings for the cameras in the environment, in some embodiments.

Selecting particular cameras 110 to be able to capture images and/or video of talkers for a particular matching environment configuration template may include assigning whether a particular camera 110 can be controlled to point at a talker in a particular location and/or at a camera preset in an environment. For example, in the classroom of FIG. 6, the camera 604a may be assigned to be controlled to point at active talkers detected at locations 612 and/or at camera presets 620, while the camera 604b may be assigned to be controlled to point at an active talker at location 613 or camera preset 621. As another example, in the collaboration space of FIG. 7, the camera 704a may be assigned to be controlled to point at talkers at locations 712 and/or at camera presets 720 that are facing it or nearer to it, while the camera 704b may be assigned to be controlled to point at talkers at locations 712 and/or at camera presets 720 that are facing it or nearer to it.

The cameras 110 may also be controlled in certain ways for a particular matching environment configuration template to point at talkers when the locations of the talkers are sensed by a microphone array 102. For example, a particular pan, tilt, and/or zoom setting of a camera 110 may be preconfigured for the matching environment configuration template due to the locations of the camera 110, talkers, and/or objects in the environment. As an example, in the classroom configuration of FIG. 6, the camera 604b may have a default tighter zoom setting since it may primarily be used to capture images and/or video of a talker at location 613 (e.g., a teacher or professor). As another example, in the boardroom configuration of FIG. 8, the camera 804a may have a default wider zoom setting in order to capture images and/or video of all of the people sitting around the tables 810a, 810b simultaneously.

After the camera configuration has been set up at step 310, the cameras 110 may be optimized for the particular physical configuration of the environment. In particular, talkers in the environment can be detected by the microphone arrays 102 and images and/or video of the talkers can be more optimally captured by the cameras 110. The captured images and/or video of the talkers may be transmitted to remote far end participants of a conferencing session, for example.

In some embodiments, the coverage areas of the microphone arrays 102 may be configured at step 310 for the corresponding physical configuration of the environment to optimally detect talkers in the environment, for example. Configuring the coverage areas of the microphone array 102 may include, for example, steering the lobes of one or more of the microphone arrays 102 towards a desired sound (e.g., a talker) and/or away from an undesired sound (e.g., noise).

In embodiments, the configuration of the coverage areas may be based on the matching environment configuration template, such as to capture the sound of talkers where they would typically be located for the corresponding physical configuration of the environment. As an example, in the classroom configuration of FIG. 6, the microphone array 602 may be configured to have coverage areas where the teacher/professor is typically located (e.g., location 613) and where the students are typically located (e.g., locations 612). As another example, in the collaboration space of FIG. 7, the microphone array 702 may be configured to have coverage areas for each of the tables 710. As a further example, in the boardroom configuration of FIG. 8, the microphone array 802a may be configured to have coverage areas for the larger room while the microphone array 802b may be configured to have coverage areas for the smaller room.

The description herein describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A method, comprising:
receiving sensor data associated with one or more talkers located in an environment;
comparing the sensor data to a plurality of environment configuration templates, wherein each of the plurality of environment configuration templates is associated with a particular physical configuration of the environment; and
when the sensor data matches one of the plurality of environment configuration templates:
selecting a matching environment configuration template; and
configuring one or more cameras located in the environment, based on the matching environment configuration template.

2. The method of claim 1, wherein the sensor data comprises locations of the one or more talkers in the environment.

3. The method of claim 2, wherein the locations of the one or more talkers in the environment are determined using a microphone and based on audio associated with the one or more talkers.

4. The method of claim 2, wherein the locations of the one or more talkers in the environment are determined using the one or more cameras.

5. The method of claim 2, wherein each of the plurality of environment configuration templates comprises potential locations of the one or more talkers that are associated with the particular physical configuration of the environment.

6. The method of claim 1, wherein the sensor data is further associated with one or more objects in the environment, and the sensor data comprises locations of the one or more objects in the environment.

7. The method of claim 6, wherein each of the plurality of environment configuration templates comprises potential locations of one or more objects that are associated with the particular physical configuration of the environment.

8. The method of claim 1, wherein the environment is physically divisible, and wherein the sensor data is further associated with a state of the physically divisible environment.

9. The method of claim 1, further comprising when the sensor data matches one of the plurality of environment configuration templates, retrieving the matching environment configuration template from a database.

10. The method of claim 1, wherein configuring the one or more cameras comprises setting one or more presets for the one or more cameras, based on the matching environment configuration template.

11. The method of claim 1, wherein configuring the one or more cameras comprises selecting at least one of the one or more cameras for capturing images of the one or more talkers, based on the matching environment configuration template.

12. The method of claim 2, wherein configuring the one or more cameras comprises transmitting the locations of the one or more talkers to the one or more cameras to cause the one or more cameras to point towards the locations of the one or more talkers, based on the matching environment configuration template.

13. The method of claim 1, further comprising when the sensor data matches one of the plurality of environment configuration templates, configuring a coverage area of a microphone located in the environment, based on the matching environment configuration template.

14. A system, comprising:
a microphone configured to determine locations of one or more talkers in an environment, based on audio sensed by the microphone and associated with the one or more talkers; and
an aggregator unit in communication with the microphone and one or more cameras, the aggregator unit configured to:
determine a physical configuration of the environment, based on the locations of the one or more talkers; and
configure the one or more cameras in the environment to capture images of the one or more talkers, based on the determined physical configuration.

15. The system of claim 14, wherein the one or more cameras are configured to determine the locations of the one or more talkers.

16. The system of claim 14, wherein the aggregator unit is configured to determine the physical configuration of the environment based on a comparison of the locations of the one or more talkers with predetermined potential locations of the one or more talkers that are stored in a database in communication with the aggregator unit.

17. The system of claim 16, wherein the aggregator unit is configured to determine the physical configuration of the environment based on whether a number of the locations of the one or more talkers meets a threshold of the predetermined potential locations.

18. The system of claim 14, wherein the aggregator unit is configured to configure the one or more cameras by setting one or more presets for the one or more cameras.

19. The system of claim 14, wherein the aggregator unit is configured to configure the one or more cameras by transmitting the locations of the one or more talkers to the one or more cameras to cause the one or more cameras to point towards the locations of the one or more talkers.

20. The system of claim 14, wherein the aggregator unit is further configured to configure a coverage area of the microphone, based on the determined physical configuration.
